(19) United States
(12) Patent Application Publication
(10) Pub. No.: US 2021/0176049 A1
(43) Pub. Date: Jun. 10, 2021

(54) TRUSTED EXECUTION ENVIRONMENT- BASED KEY MANAGEMENT METHOD

(71) Applicant: TEEware Co., Ltd., Daejeon (KR)

(72) Inventors: Nohyun Kwak, Daejeon (KR); Yunjong Jeong, Daejeon (KR)

(21) Appl. No.: 17/111,610

(22) Filed: Dec. 4, 2020

(30) Foreign Application Priority Data
Dec. 9, 2019 (KR) 10-2019-0162342
Aug. 13, 2020 (KR) 10-2020-0101595

(51) Int. Cl. H04L 9/08; G06F 21/57

(52) U.S. Cl. CPC H04L 9/0822; G06F 21/57

(57) ABSTRACT

Disclosed is a key management technology based on a trusted execution environment (TEE). A method of managing a key by a cryptographic operation apparatus incorporating a trusted execution environment may include receiving a required encryption key from a shared storage apparatus in response to a request from an application, wherein the encryption key is encrypted by a key encryption key (KEK) held within a key encryption apparatus, and the encrypted encryption key is stored in a shared storage apparatus with the shared storage apparatus making available the encryption key to multiple cryptographic operation apparatuses; decrypting the encryption key encrypted by the key encryption key (KEK) through the key encryption apparatus; and processing the request from the application using the decrypted encryption key.

### CROSS REFERENCE TO RELATED APPLICATION

This application claims priority under 35 U.S.C. § 119 to Korean Patent Application No. 10-2019-0162342 filed on Dec. 9, 2019, No. 10-2020-0101595 filed on Aug. 13, 2020, which is incorporated herein by reference in its entirety.

### BACKGROUND OF THE INVENTION

### 1. Technical Field

The following description relates to a technology for managing encryption keys.

### 2. Description of the Related Art

Presently, encryption technology is widely used by numerous computer systems for purposes such as to encrypt databases, ensure secure communication, and to authenticate. To safely utilize encryption technology, encryption keys must be managed correctly.

A secure system for managing encryption keys (i.e., a key management system) must be able to block unauthorized access to the keys. Unauthorized access includes all attacks, both a software approach as well as the physical intrusion of a system.

Current key management systems are divided into either a (1) dedicated hardware or (2) a software method.

The dedicated hardware method (e.g., a hardware security module) is able to block physical intrusions, but the financial cost is high and is cumbersome because additional hardware modules must be physically installed to increase throughput.

The software method (e.g., a software key management server) can more readily extend throughput because only a program needs to be installed and executed. However, the software method cannot block physical intrusions because the encryption keys are stored unsecured within general-purpose servers.

### SUMMARY OF THE INVENTION

Embodiments may provide a method and system for managing encryption keys utilizing a cryptographic operation apparatus incorporating a trusted execution environment (TEE).

The embodiment may include a cryptographic operation apparatus,
1) receiving a required encryption key from a shared storage apparatus in response to a request from an application, wherein the encryption key has been encrypted by a key encryption key (KEK) held within a key encryption apparatus, the encryption key encrypted by the KEK is stored in the shared storage apparatus with the shared storage apparatus making available the encryption key to multiple cryptographic operation apparatuses;
2) decrypting the encryption key encrypted by the key encryption key (KEK) through the key encryption apparatus in response to a request for decryption; and
3) processing the application's request using the decrypted encryption key.

Receiving the required encryption key may include, receiving a request for a cryptographic operation from the application, determining whether an encryption key related to the received request is present in the shared storage apparatus, and when the encryption key is present, receiving from the shared storage apparatus the encrypted encryption key.

Decrypting the encryption key may include, receiving from the key encryption apparatus the encryption key decrypted by the key encryption key (KEK), in response to a request for decryption through the key encryption apparatus.

Processing the request may include, processing a request for a cryptographic operation using the encryption key decrypted by the key encryption key (KEK) through the key encryption apparatus, and transmitting the results of the cryptographic operation to the application.

Processing the request may include, storing in the shared storage apparatus an encryption key generated as the request for the cryptographic operation is processed. The encryption key generated as the request for the cryptographic operation is processed may be encrypted by the key encryption key (KEK) included in the key encryption apparatus.

A cryptographic operation apparatus incorporating a trusted execution environment (TEE) for key management may include: 1) an encryption key receiver configured to receive a required encryption key from a shared storage apparatus in response to a request from an application, wherein the encryption key is encrypted by a key encryption key (KEK) included in a key encryption apparatus and stored in a shared storage apparatus, with the shared storage apparatus making available the encryption key to multiple cryptographic operation apparatuses; 2) an encryption key decryptor configured to decrypt the encryption key encrypted by the key encryption apparatus using the key encryption key (KEK); and 3) a request processor configured to process the request from the application using the decrypted encryption key.

The encryption key receiver may receive a request for a cryptographic operation from the application, may determine whether an encryption key related to the received request for the cryptographic operation is present in the shared storage apparatus, and when the encryption key is present, may receive from the shared storage apparatus the encrypted encryption key related to the received request for the cryptographic operation.

The encryption key decryptor may receive, in response to a request for decryption through the key encryption apparatus, the decrypted encryption key from the key encryption apparatus.

The request processor may process a request for a cryptographic operation using the encryption key decrypted by the key encryption apparatus using the key encryption key (KEK), and may transmit the results of the processing of the request for the cryptographic operation to the application.

The request processor may store, in the shared storage apparatus, an encryption key generated as the request for the cryptographic operation is processed. The encryption key generated as the request for the cryptographic operation is processed may be encrypted by the key encryption key (KEK) within the key encryption apparatus.

### BRIEF DESCRIPTION OF THE DRAWINGS

FIG. 1 is a diagram illustrating a configuration of a cryptographic operation apparatus, according to an embodiment.

FIG. 2 is a diagram illustrating the operation of managing, by a cryptographic operation apparatus, a trusted execution environment (TEE)-based key management system, according to an embodiment.

FIG. 3 is a diagram illustrating an operation of processing, by the cryptographic operation apparatus, a cryptographic operation request, according to an embodiment.

FIG. 4 is a block diagram illustrating elements of the cryptographic operation apparatus according to an embodiment.

FIG. 5 is a flowchart illustrating a method of managing, by a cryptographic operation apparatus, a trusted execution environment (TEE)-based key management system, according to an embodiment.

### DETAILED DESCRIPTION

Hereinafter, various embodiments of this invention are described with reference to the accompanying drawings.

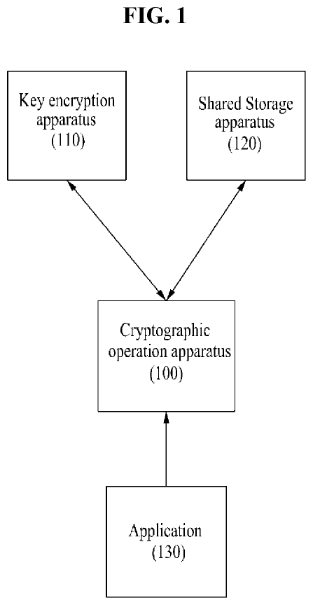

FIG. 1 is a diagram illustrating a configuration of a cryptographic operation apparatus 100 according to an embodiment.

The cryptographic operation apparatus 100 is a device for processing a request from an application 130. The cryptographic operation apparatus 100 may receive a request from the application 130 and perform a cryptographic operation. The cryptographic operation apparatus 100 may incorporate a trusted execution environment (TEE).

In the case of a computing apparatus incorporating a trusted execution environment (TEE), the computing apparatus may be configured as a cryptographic operation apparatus 100 by installing a cryptographic operation software on the device. Because computing devices providing a trusted execution environment (TEE) are readily available and widely disseminated, a cryptographic operation apparatus can be rapidly constructed by the installation of software on the computing apparatus. It is also possible to construct a cryptographic operation apparatus on certain cloud platforms.

The key encryption apparatus 110 is an apparatus for encrypting or decrypting an encryption key using a key encryption key (KEK). In an embodiment, the key encryption apparatus 110 is not limited to a specific device but refers to any processing device that can perform the function of encrypting or decrypting a key. For example, various servers, including a hardware security module (HSM) or a software key management server, may become the key encryption apparatus 110.

The key encryption apparatus 110 may generate a key encryption key (KEK) or receive a key encryption key (KEK) from the application 130. The key encryption key (KEK) may be stored in the key encryption apparatus 110.

A shared storage apparatus 120 is an apparatus for storing an encrypted encryption key. For example, the shared storage apparatus 120 refers to a space in which an encrypted encryption key is stored, and may be a database. Multiple encrypted encryption keys may be stored in the shared storage apparatus 120. The multiple encrypted encryption keys may be different or the same type of encryption keys.

The application 130 may make a request to the cryptographic operation apparatus 100. When this is the case, the application 130 may request a cryptographic operation from the cryptographic operation apparatus 100. Examples of cryptographic operations may include not only asymmetric key operations, but also symmetric key operations, key generation, and the induction of child keys.

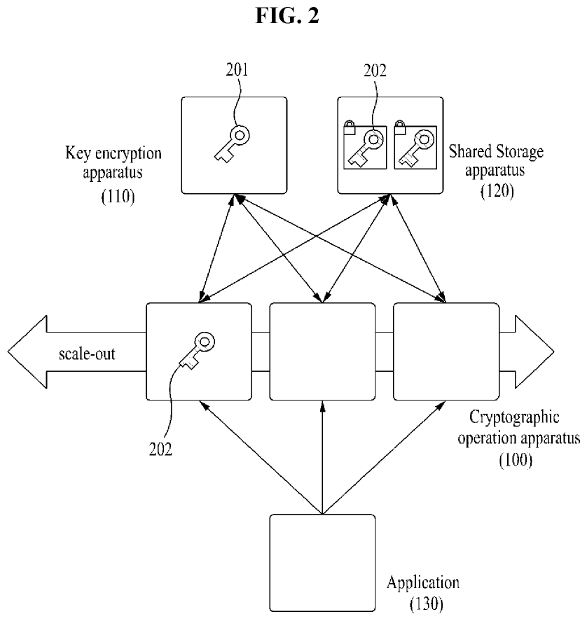

FIG. 2 is a diagram illustrating an operation of managing, by a cryptographic operation apparatus 100, a trusted execution environment (TEE)-based key management system, according to an embodiment.

The cryptographic operation apparatus 100 may perform cryptographic operations using an encryption key within a trusted execution environment (TEE). As illustrated in FIG. 2, multiple cryptographic operation apparatuses may be configured. Cryptographic operations may be simultaneously processed through the multiple cryptographic operation apparatuses.

The cryptographic operation apparatus 100 may receive a required encryption key 202 in response to a request from the application 130. The cryptographic operation apparatus 100 may receive a request for a cryptographic operation from the application 130.

The cryptographic operation apparatus 100 may determine whether an encryption key related to the received request for the cryptographic operation is present. If the encryption key 202 is present, the cryptographic operation apparatus 100 may receive from the shared storage apparatus 120 the encrypted encryption key related to the received request. Multiple cryptographic operation apparatuses 100 may access the key encryption key (KEK) 201 in a like manner. Moreover, multiple cryptographic operation apparatuses 100 may also access the shared storage apparatus 120. In this case, an encryption key 202 can be shared among all the cryptographic operation apparatuses. The encryption key 202 can be managed without limit as to the type of encryption key 202. In an embodiment, the cryptographic operation apparatus 100 may perform various cryptographic operations, such as asymmetric and symmetric key operations, as well as key generation, and the induction of child keys.

In this case, the encryption key 202 encrypted by the key encryption key (KEK) 201 held within the key encryption apparatus 110, may be stored in the shared storage apparatus 120. The shared storage apparatus 120 may share the encryption key 202 with multiple cryptographic operation apparatuses 100.

The cryptographic operation apparatus 100 may perform the functions that comprise the processing of cryptographic operations. The cryptographic operation apparatus 100 may decrypt, through the key encryption apparatus 110, the encryption key 202 encrypted by the key encryption key (KEK) 201. The cryptographic operation apparatus 100 may request the decryption from the key encryption apparatus 110. In response thereto, the key encryption apparatus 110 may decrypt the encryption key 202 encrypted by the key encryption key (KEK) 201. The cryptographic operation apparatus 100 may receive the decrypted encryption key 202.

The cryptographic operation apparatus 100 may process a request from the application 130 using the decrypted encryption key 202. In this case, the request from the application 130 may be the processing of a cryptographic operation. The cryptographic operation apparatus 100 may perform the cryptographic operation using an encryption key retrieved from the shared storage apparatus 120. In this case, when a new encryption key is generated as the result of the processing of the request for the cryptographic operation, the newly generated encryption key may be stored in the shared storage apparatus 120. The results of the processing of the request for the cryptographic operation may be delivered to the application 130. Throughput for cryptographic operations can be horizontally scaled out by configuring additional cryptographic operation apparatuses 100, as illustrated by FIG. 2.

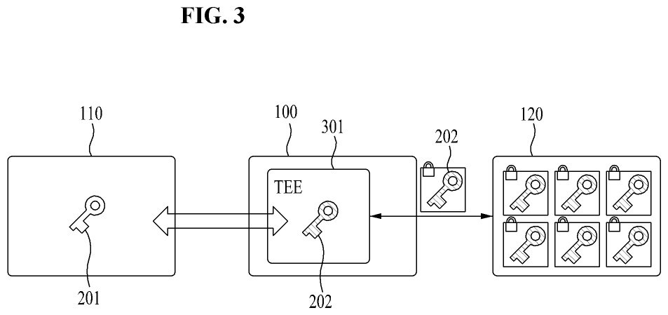

FIG. 3 is a diagram illustrating an operation of processing a cryptographic operation request by the cryptographic operation apparatus, according to an embodiment.

As described above, the cryptographic operation apparatus 100 may be arranged as a configuration of multiple cryptographic operation apparatuses, but for ease of illustration one cryptographic operation apparatus is depicted as an example with reference to FIG. 3. The cryptographic operation apparatus 100 may perform cryptographic operations within a trusted execution environment (TEE) 301. Because the memory has been encrypted by the trusted execution environment (TEE), although the encryption key 202 is present in the memory of the cryptographic operation apparatus 100, an attacker cannot hijack the encryption key.

An operation of generating a key is described below. For example, an encryption key 202 may be generated by the cryptographic operation apparatus 100 as the result of an execution of a request from the application. Alternatively, the cryptographic operation apparatus 100 may generate the encryption key 202 according to preset criteria. The cryptographic operation apparatus 100 may encrypt the encryption key 202 through the key encryption apparatus 110 using the key encryption key (KEK) 201. The encrypted encryption key 202 may be stored in the shared storage apparatus 120.

An execution of a cryptographic operation is described below. The cryptographic operation apparatus 100 may receive an encrypted encryption key 202 from the shared storage apparatus 120. For example, the cryptographic operation apparatus 100 may receive data from the shared storage apparatus 120.

The key encryption apparatus 110 may encrypt or decrypt the encryption key 202 using the key encryption key (KEK) 201. The key encryption apparatus 110 may receive an encryption or decryption request from the cryptographic operation apparatus 100. The cryptographic operation apparatus 100 may perform encryption or decryption on the encryption key 202 using the key encryption key (KEK) 201. Specifically, the cryptographic operation apparatus 100 may decrypt data received from the shared storage apparatus 120, using the key encryption apparatus 110. The cryptographic operation apparatus 100 may extract the encryption key 202 from the decrypted data.

The encryption key 202 may be encrypted by the key encryption key (KEK) 201 held within the key encryption apparatus 110, and may be stored in the shared storage apparatus 120. The shared storage apparatus 120 may share, with the cryptographic operation apparatus 100, the encryption key 202 encrypted by the key encryption key (KEK) 201. The cryptographic operation apparatus 100 may decrypt the encryption key 202 through the key encryption apparatus 110 using the key encryption key (KEK) 201. The cryptographic operation apparatus 100 may perform a cryptographic operation using the encryption key 202. The cryptographic operation apparatus 100 may deliver, to the application 130, the results obtained by performing the cryptographic operation using the encryption key 202.

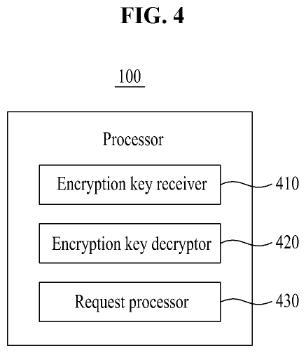

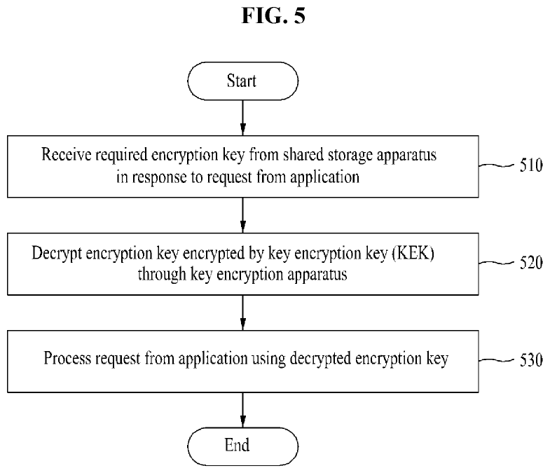

FIG. 4 is a block diagram illustrating elements of the cryptographic operation apparatus 100, according to an embodiment. FIG. 5 is a flowchart illustrating a method of managing a key by a trusted execution environment-based cryptographic operation apparatus, according to an embodiment.

The processor of cryptographic operation apparatus 100 may include an encryption key receiver 410, an encryption key decryptor 420, and a request processor 430. The elements of the processor may be expressions of different functions performed by the processor in response to a control command issued by a program code stored in an electronic device. The processor and the elements of the processor may control the cryptographic operation apparatus that performs steps 510 to 530 comprising the method of managing a key based on a trusted execution environment (TEE), as illustrated in FIG. 5. In this case, the processor and the elements of the processor may be implemented to execute instructions issued pursuant to the code of an operating system included in a memory, and the code of at least one program.

The processor may load onto the memory a program code stored in the file of a program for the trusted execution environment (TEE)-based management of keys. For example, when the program is executed in the cryptographic operation apparatus, the processor may command the cryptographic operation apparatus to load the program code onto the memory from the file of the program under the control of the operating system. In this case, the processor, the encryption key receiver 410, the encryption key decryptor 420, and the request processor 430 included in the processor may be expressions of different functions of the processor for subsequently executing steps 510 to 530 by executing an instruction of a corresponding portion of the program code loaded onto the memory.

At step 510, the encryption key receiver 410 may receive a required encryption key from the shared storage apparatus in response to a request from the application. The encryption key receiver 410 may receive the request for the cryptographic operation from the application, and may determine whether an encryption key related to the received request is present in the shared storage apparatus. If such an encryption key is present, the encryption key receiver 410 may receive from the shared storage apparatus, the encrypted encryption key related to the received request for the cryptographic operation.

At step 520, the encryption key decryptor 420 may decrypt, through the key encryption apparatus, the encryption key encrypted by the key encryption key (KEK). When a request for decryption is made through the key encryption apparatus, the encryption key encrypted by the key encryption key (KEK) is decrypted by the key encryption apparatus, and the encryption key decryptor 420 may receive the decrypted encryption key.

At step 530, the request processor 430 may process the request from the application using the decrypted encryption key. The request processor 430 may process the request for the cryptographic operation using the encryption key that has been decrypted using the key encryption key (KEK) through the key encryption apparatus, and may transmit the results of the processing of the request for the cryptographic operation to the application. The request processor 430 may store, in the shared storage apparatus, an encryption key generated as the request for the cryptographic operation is processed. In this case, the encryption key generated as the request for the cryptographic operation is processed may have been encrypted by the key encryption key (KEK) held within the key encryption apparatus.

The aforementioned apparatus (or device) may be implemented as a hardware component, a software component and/or a combination of both. For example, the apparatus and components described in the embodiments may be implemented using one or more general-purpose or special-purpose computers, for example, a processor, a controller, an arithmetic logic unit (ALU), a digital signal processor, a microcomputer, a field programmable gate array (FPGA), a programmable logic unit (PLU), a microprocessor or any other device capable of executing or responding to an instruction. The processing device (or processor) may run an operating system (OS) and one or more software applications executed on the OS. Furthermore, the processing device may access, store, manipulate, process and generate data in response to the execution of software. For convenience of understanding, one processing device has been illustrated as being used, but a person having ordinary skill in the art may understand that the processing device may include multiple processing elements and/or multiple types of processing elements. For example, the processing device may include multiple processors or a single processor and a single controller. Furthermore, other processing configurations, such as a parallel processor, are also possible.

Software may include a computer program, code, an instruction or a combination of one or more of the aforementioned and may control and configure a processor so that it operates as desired or may instruct processors independently or collectively. The software and/or data may be embodied in any type of a machine, component, physical device, virtual equipment, or computer storage medium or device so as to be executed by the processor or to provide instruction or data to the processor. The software may be distributed to computer systems connected over a network and may be stored or executed in a distributed manner. The software and data may be stored in one or more computer-readable recording media.

The embodiment may be implemented in the form of a program instruction executable by various computer means and stored in a computer-readable recording medium. The computer-readable recording medium may include a program instruction, a data file, and/or a data structure, either alone or in combination. The program instructions stored in the medium may be specially designed and constructed for the present disclosure, or may be known and available to those skilled in the field of computer software. Examples of the computer-readable storage medium include: magnetic media such as a hard disk, a floppy disk and a magnetic tape; optical media such as a CD-ROM and a DVD; magneto-optical media such as a floptical disk; and hardware devices specially configured to store and execute program instructions such as a ROM, a RAM, and flash memory. Examples of the program instructions include not only machine language code constructed by a compiler but also high-level language code that can be executed by a computer using an interpreter or such intermediary.

Encryption keys can be efficiently managed using the cryptographic operation apparatus constructed by installing cryptographic operation software on a computing apparatus incorporating a trusted execution environment.

Throughput for processing requests from applications can be horizontally scaled out by configuring additional cryptographic operation apparatuses incorporating a trusted execution environment (TEE), and shared storage apparatuses.

Because the memory has been encrypted by the trusted execution environment (TEE), although the encryption key is present in the memory of the cryptographic operation apparatus, attackers cannot hijack the key. Accordingly, key management can be safely performed.

As described above, although the embodiments have been described in connection with limited embodiments and drawings, those skilled in the art may modify and change the embodiments in various ways from the description. For example, proper results may be achieved although the above descriptions are performed in an order different from that of the described method and/or the aforementioned elements, such as the system, configuration, device, and circuit, are coupled or combined in a form different from that of the described method or replaced or substituted with other elements or equivalents.

Accordingly, other implementations, other embodiments, and equivalents of the claims fall within the scope of the claims.

What is claimed is:

1. A method of managing a key by a cryptographic operation apparatus incorporating a trusted execution environment (TEE), the method comprising:
receiving a required encryption key from a shared storage apparatus in response to a request from an application—wherein the encryption key is encrypted by a key encryption key (KEK) held within a key encryption apparatus, the encryption key encrypted by the KEK is stored in the shared storage apparatus with the shared storage apparatus making available the encryption key to multiple cryptographic operation apparatuses—;
decrypting the encryption key encrypted by the key encryption key (KEK) through the key encryption apparatus; and
processing the request from the application using the decrypted encryption key.

2. The method of claim 1, wherein receiving the required encryption key comprises:
receiving a request for a cryptographic operation from an application,
determining whether an encryption key related to the received request for the cryptographic operation is present in the shared storage apparatus, and
when the encryption key is present, receiving from the shared storage apparatus, the encrypted encryption key related to the received request for the cryptographic operation.

3. The method of claim 1, wherein decrypting the encryption key comprises receiving, from the key encryption apparatus, the decrypted encryption key, in response to a request for decryption through the key encryption apparatus.

4. The method of claim 1, wherein processing the request comprises:
processing a request for a cryptographic operation using the encryption key decrypted by the key encryption key (KEK) through the key encryption apparatus, and
transmitting the results of the processing of the cryptographic operation to the application.

5. The method of claim 1, wherein:
processing the request comprises storing, in the shared storage apparatus, an encryption key generated as the request for the cryptographic operation is processed, and
the generated encryption key is encrypted by the key encryption key (KEK) held within the key encryption apparatus.

6. A cryptographic operation apparatus incorporating a trusted execution environment (TEE) for key management, comprising:
an encryption key receiver configured to receive a required encryption key from a shared storage apparatus in response to a request from an application, wherein the encryption key is encrypted by a key encryption key (KEK) held within a key encryption apparatus, the encryption key encrypted by the KEK is stored in the shared storage apparatus with the shared storage apparatus making available the encryption key to multiple cryptographic operation apparatuses;
an encryption key decryptor configured to decrypt the encryption key encrypted by the key encryption key (KEK) through the key encryption apparatus; and
a request processor configured to process the request from the application using the decrypted encryption key.

7. The cryptographic operation apparatus of claim 6, wherein the encryption key receiver receives a request for a cryptographic operation from the application, determines whether an encryption key related to the received request for the cryptographic operation is present in the shared storage apparatus, and when the encryption key is present, receives from the shared storage apparatus, the encrypted encryption key related to the received request for the cryptographic operation.

8. The cryptographic operation apparatus of claim 6, wherein the encryption key decryptor receives, from the key encryption apparatus, the decrypted encryption key, in response to a request for decryption through the key encryption apparatus.

9. The cryptographic operation apparatus of claim 6, wherein the request processor processes a request for a cryptographic operation using the encryption key decrypted by the key encryption key (KEK) through the key encryption apparatus, and transmits the results of the processing of the cryptographic operation to the application.

10. The cryptographic operation apparatus of claim 6, wherein:
the request processor stores, in the shared storage apparatus, an encryption key generated as the request for the cryptographic operation is processed, and
the encryption key generated as the request for the cryptographic operation is processed is encrypted by the key encryption key (KEK) held within the key encryption apparatus.
